(19) United States
(12) Patent Application Publication
(10) Pub. No.: US 2004/0108441 A1
(43) Pub. Date: Jun. 10, 2004

(54) Variable-force balancing device in particular for movable-axis hinges of electric household appliances and the like

(76) Inventor: Angelo Bettinzoli, Bareggio (IT)

Correspondence Address: WILDMAN, HARROLD, ALLEN & DIXON, 225 WEST WACKER DRIVE, CHICAGO, IL, 60606, US

(21) Appl. No.: 10/718,100

(22) Filed: Nov. 20, 2003

(30) Foreign Application Priority Data
Dec. 10, 2002 (IT) MI2002A 002610

(51) Int. Cl. F16M 13/00

(52) U.S. Cl. 248/565

(57) ABSTRACT

Load-balancing device in particular for movable-axis hinges, which comprises a sliding piece/sleeve provided with means for retaining a first end of a first coaxial spring, the other end of which has at least one fastening element, there being slidable coaxially with said sliding piece/sleeve and with said first spring a spindle, one end of which, inside said spring, has first means for retaining one end of a second spring which is coaxial with the first spring and the other end of which is housed inside a corresponding seat of the said sleeve, said first spring having a load greater than said second spring.

### CROSS REFERENCE TO RELATED APPLICATION

This application claims priority of Italian Patent Application Serial No. MI2002A 002610 filed Dec. 10, 2002.

### BACKGROUND

The present invention relates to a load-balancing device in particular for movable-axis hinges.

It is known in the technology relating to the manufacture of electric household appliances such as ovens, dishwashers and the like that there exists the need to equip said appliances with doors which can be opened rotationally about a horizontal axis so as to allow access to the compartment situated at the rear.

Connecting hinges for said electric appliances are also known, said hinges comprising a part which is integral with the door and movable with the latter and which supports the arms of the hinge which can be engaged with the fixed part thereof integral with the structure of the electric appliance.

It is also known that said hinges have, in their movable part, a spring which is able to keep the door as balanced as possible during rotational opening and closing thereof, exerting an action which, in the first case, prevents the door from falling and, in the second case, favours the return movement upwards, reducing the amount of effort which the user must apply in order to perform the two manoeuvres.

In the more recent embodiments of ovens and the like, owing to the increasingly higher internal temperature which is required and able to be achieved, the closing doors must be made with cavity glass of greater thickness, resulting in a considerable increase in the overall weight of the said door.

A similar problem, arising from the weight of the door, is also posed in the case of dishwashers having a door lined with a finishing panel.

This increased weight obviously results in the need to design with extra large dimensions all the component parts of the hinge, such as the pins, arms and in particular the balancing spring, which must be increased both as regards its overall dimensions and as regards calibration of the force which can be exerted, consequently resulting in the need for the user to

apply a considerable amount of force in order to be able to open the door and, vice versa, restrain it during closing.

This problem is further complicated in the case of hinges for built-in furniture units, where the axis of rotation of the arm of the hinge varies its position during the opening/closing rotation of the door, consequently resulting in a further variation in the forces to be applied in order to balance the door.

The technical problem which is posed, therefore, is that of providing a device for balancing hinges, in particular with a movable axis, for doors of electric household appliances and the like, which is able to vary automatically the balancing force of the door during the various stages of opening/closing thereof.

Within the scope of this problem it is furthermore required that said device should be easy and inexpensive to manufacture and applicable to hinges of the conventional type with the need for special adaptation.

These technical problems are solved according to the present invention by a load-balancing device in particular for movable-axis hinges, which comprises a sleeve provided with means for retaining a first end of a first coaxial spring, the other end of which has a fastening element, there being slidable coaxially with said sleeve and with said first spring a spindle, one end of which, inside said spring, has first means for retaining one end of a second spring which is coaxial with the first spring and the other end of which is housed inside a corresponding seat of the said sleeve, said first spring having a load greater than said second spring.

The present invention also relates to a hinge, in particular with a movable axis, for doors of electric household appliances and the like, provided with a balancing device able to apply a different force during the various stages of opening/closing of the said doors as described above.

Further details and characteristic features will become obvious from the following description of a non-limiting example of embodiment of the device according to the invention, provided with reference to the accompanying figures, in which:

### BRIEF DESCRIPTION OF THE DRAWINGS

FIG. 1 shows a cross-section along an axial plane of the balancing device according to the present invention in the rest condition;

FIG. 2 shows a partially sectioned view of the device according to FIG. 1 during application of a first smaller balancing force;

FIG. 3 shows a partially sectioned view of the device according to FIG. 1 during application of a second greater balancing force;

FIG. 4 shows a side view of movable-axis hinge provided with a balancing device in the rest condition;

FIG. 5 shows a view similar to that of FIG. 4 with the hinge in the partially open/closed condition;

FIG. 6 shows a view similar to that of FIG. 4 with the hinge totally open;

FIG. 7 shows a view of a variation of embodiment of the hinge according to the present invention; and

FIG. 8 shows a cross-section along the plane indicated by VIII-VIII in FIG. 7.

### DETAILED DESCRIPTION OF THE DRAWINGS

As illustrated, the variable-force balancing device according to the invention is essentially formed by a sliding piece/sleeve 10 provided with a head 11 one side of which is provided with a seat 11a for housing one end of a first, coaxial, high-load spring 20, the other end of which has a fastening element consisting, in the example shown, of a hook 21.

A spindle 30 is coaxially slidable inside said sleeve 10 and therefore said first spring 20, said spindle having one end, inside said spring 20, having a head 31 provided with a seat 31a for housing one end of second spring 40, the other end of which is housed in a corresponding seat 11b in the surface of the sleeve, opposite to the said head 11.

The outer free end of said spindle 30 has a hole 32 suitable for coupling with corresponding fastening means (not shown); it is envisaged, moreover, that a section 33 of said spindle adjacent to the head 31 has a widened cross-section so as to prevent the sleeve 10 from coming off.

At the opposite end the spindle 30 also has two projections 30a which form the end-of-travel stop for the sliding piece 10 towards the outer free end of the said spindle.

In a preferred embodiment, the first spring 20 is of the extension type, while the second spring 40 is of the compression type, both the springs being suitably calibrated in order to produce a high difference in load.

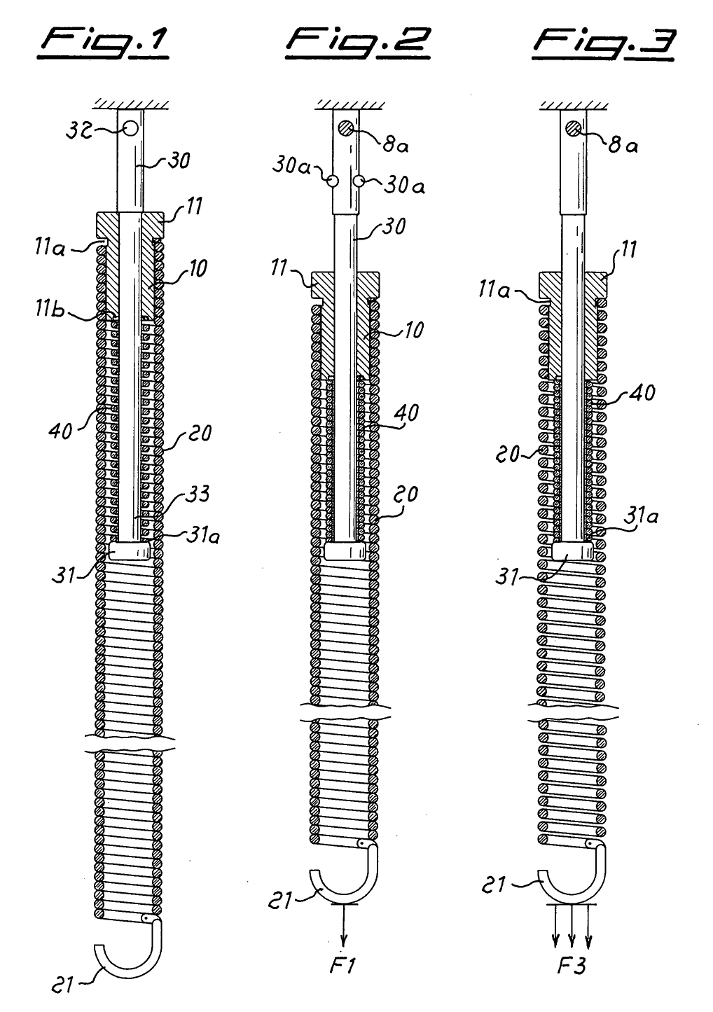

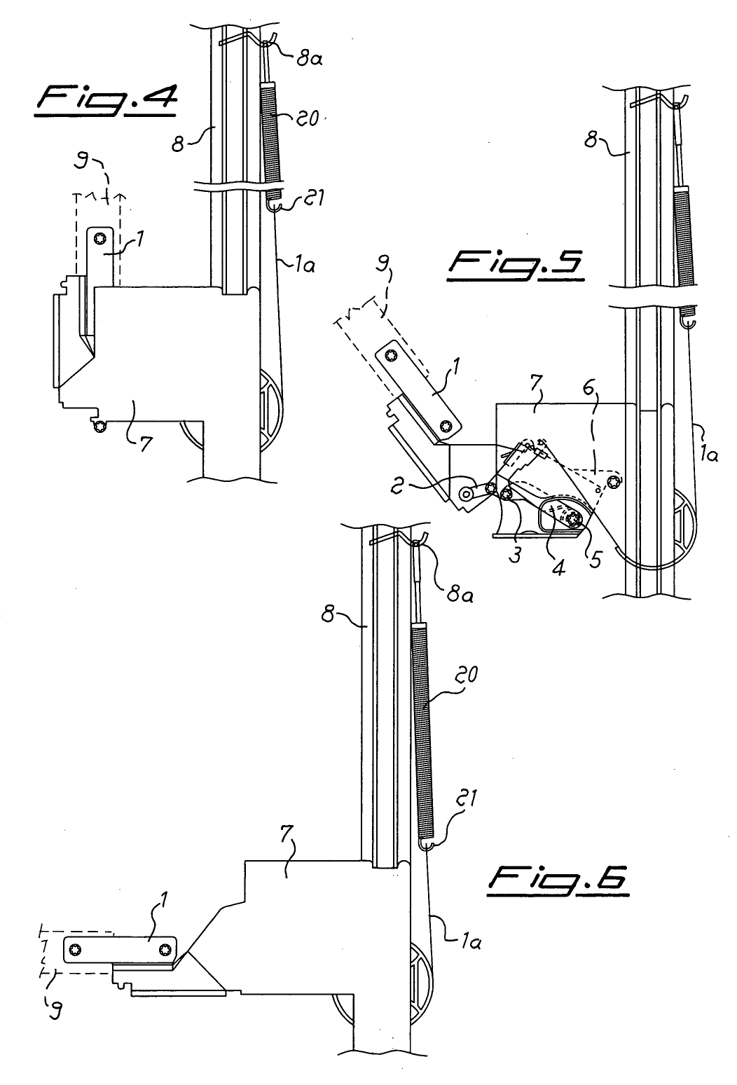

As illustrated in FIGS. 2 and 3, the operating principle of the device is as follows:

Once the spindle 30 has been fastened to a fixed point 8a, by means of its end hole 32, and the first spring 20 has been fastened to the load by means of its hook 31;

when the device is subjected to a first load of limited magnitude schematically indicated by an arrow F1, the greater resistive force of the first spring 20 prevents it from reacting, resulting in a displacement (downwards in the figure) of the head 11 of the sleeve 10 which causes the compression—and therefore reaction—of the second spring 40 having a smaller resistance;

when the load F3 applied to the hook 21 of the first spring 20 is increased, the sleeve 10 moves to the end of its travel path, activating the higher-load spring 20 which starts to react, extending as far as permitted by its dimensions, producing a corresponding reaction to the load.

FIGS. 7 and 8 show a variation of embodiment of the hinge according to the present invention: in this embodiment it is envisaged that the sliding piece 110 is formed by a bolt with a threading 110a having a suitable pitch for allowing screwing of the external spring 20 thereon, said spring acting as a female thread and, following screwing, remaining firmly fastened to the sliding piece.

It is envisaged moreover that the spindle 130 has a constant cross-section along the whole of its axial length and that the end-of-travel stop of the sliding piece is in this case is produced by means of the total compression of the inner spring 40.

As illustrated in FIG. 4 a further aspect of the present invention relates to a hinge for electric household appliances, furniture and the like of the type with a movable-axis, which being conventional per se is only schematically illustrated in the form of a first arm 1 hinged by means of a transmission piece 2 with a pin 3 forming the movable axis of rotation on which the first end of a second arm 4 is also hinged, the other end being integral with a pin 5 mounted on a plate 6 for fastening to a support 7 in turn connected to an upright 8 of the electric household appliance, furniture or the like.

The arm 1 of the hinge is in turn fastened to the door 9 and, as shown in FIGS. 4, 5 and 6, during opening and closing of the latter, the axis 3 performs a displacement along a vertical plane.

The end of the arm 1 opposite to that fastened to the door 9 is connected to a first end of a cable 1a, the other end of which is attached to the hook 21 of the first spring 20 of the balancing device described above, which is fastened to a fixed hook 8a of the upright 8 by means of the hole 32 in the spindle 30.

With this configuration, during the first stage of opening or last stage of closing (FIG. 5), the rotation of the arm 1 causes pulling of the spring 20 which, having a resistance greater than the limited load of the door during said first opening stage/last closing stage, does not extend, resulting instead in displacement of the sleeve 10 against the reaction of the second spring 40, the limited force of which reacts to compression, correctly balancing the reduced load of the door 9 during said first opening stage/last closing stage.

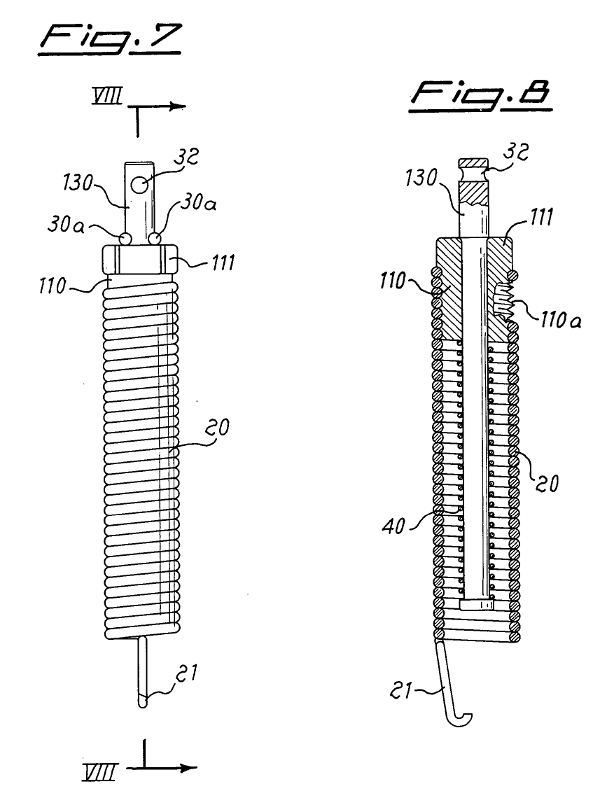

Once the axis 3 has reached its upper point of instability, corresponding to the end-of-travel point of the sliding piece 10, further opening of the door 9 produces a load on the hinge arm 1 which is much greater than the preceding load, causing activation of the first spring 20 with a greater load which, from this moment on, will balance the increased weight of the door until the fully open position shown in FIG. 6 is reached.

Similarly, the balancing device will recall the hinge arm 1 during closing of the door 9, correspondingly reducing the force which the user must apply in order to raise the latter.

It is pointed out, however, how the subsequent and varied action of the differently loaded springs correctly balances the different weight of the door during subsequent closing stages thereof, making it possible in particular to ensure correct functioning for movable-axis hinges.

It is envisaged moreover that, by suitably designing the dimensions of the balancing device according to the invention, it is also possible to keep the door open in predefined positions without the need for any action on the part of the user.

1. A load-balancing device for movable-axis hinges, comprising: a sliding piece/sleeve provided with means for retaining a first end of a first coaxial spring, another end of which has a fastening element, there being slidable coaxially with said sleeve and with said first spring a spindle, one end of which, inside said spring, has first means for retaining one end of a second spring which is coaxial with the first spring and the other end of which is housed inside a corresponding seat of the said sleeve, said first spring having a load greater than said second spring.

2. The device according to claim 1, wherein said means for retaining the end of said first spring comprises a seat in a head of the sleeve.

3. The device according to claim 1, wherein said sliding piece/sleeve is a bolt which is coaxially hollow.

4. The device according to claim 3, wherein said means for retaining the first end of said first spring comprises a thread of the bolt.

5. The device according to claim 4, wherein said thread of the bolt has a pitch corresponding to a pitch of the outer spring.

6. The device according to claim 1, wherein said means for fastening the second end of the first spring comprises a hook.

7. The device according to claim 1, wherein said spindle has one end, inside the first spring, having a head provided with a seat for housing one end of the second spring.

8. The device according to claim 7, wherein another end of the second spring is housed inside a corresponding seat in the surface of the sleeve, opposite to the said head thereof.

9. The device according to claim 1, wherein an outer free end of said spindle has a hole suitable for coupling with corresponding fixed fastening means.

10. The device according to claim 1, wherein said spindle has transverse projections able to form an end-of-travel stop of the sliding piece/sleeve towards an outer free end of said spindle.

11. The device according to claim 1, wherein said spindle has a section adjacent to the head with a widened section.

12. The device according to claim 1, wherein said first spring is an extension spring.

13. The device according to claim 1, wherein said second spring is a compression spring.

14. A hinge with a movable axis for doors of electric household appliances and the like comprising: a balancing device that includes a sleeve provided with means for retaining a first end of a first coaxial spring, another end of which has a fastening element, there being slidable coaxially with said sleeve and with said first spring a spindle, one end of which, inside said spring, has first means for retaining one end of a second spring which is coaxial with the first spring and the other end of which is housed inside a corresponding seat of the said sleeve, said first spring having a load greater than said second spring.

15. The hinge according to claim 14, wherein said means for retaining the end of said first spring comprises a seat formed in a head of the sleeve.

16. The hinge according to claim 14, wherein said sleeve or sliding piece is a bolt which is coaxially hollow.

17. The hinge according to claim 16, wherein means for retaining the first end of said first spring comprises a thread of the bolt.

18. The hinge according to claim 17, wherein said thread of the bolt has a pitch corresponding to the pitch of the turns of the outer spring.

19. The hinge according to claim 14, said means for fastening the second end of the first spring comprises a hook.

20. The hinge according to claim 14, wherein said spindle has an end, inside the first spring, having a head provided with a seat for housing an end of the second spring.

21. The hinge according to claim 14, wherein said spindle has transverse projections able to form an end-of-travel stop for the sliding piece/sleeve towards an outer free end of the said spindle.

22. The hinge according to claim 14, wherein the other end of the second spring is housed inside a corresponding seat in the surface of the sleeve, opposite to the said head thereof.

23. The hinge according to claim 14, wherein the outer free end of said spindle has a hole suitable for coupling with corresponding fixed fastening means.

24. The hinge according to claim 20, wherein said spindle has a section adjacent to the head with a widened cross-section.

25. The hinge according to claim 20, wherein said first spring is an extension spring.

26. The hinge according to claim 20, wherein said second spring is a compression spring.
